(19) United States
(12) Patent Application Publication
(10) Pub. No.: US 2007/0187306 A1
(43) Pub. Date: Aug. 16, 2007

(54) Filter housing and parts therefor

(76) Inventor: Jeffrey P. Pecca, Hillsborough, NJ (US)

Correspondence Address: MCCARTER & ENGLISH, LLP, FOUR GATEWAY CENTER, 100 MULBERRY STREET, NEWARK, NJ, 07102, US

(21) Appl. No.: 11/585,650

(22) Filed: Oct. 24, 2006

Related U.S. Application Data
(60) Provisional application No. 60/733,440, filed on Nov. 3, 2005.

(51) Int. Cl. B01D 35/00

(52) U.S. Cl. 210/120; 210/436; 210/445; 210/455

(57) ABSTRACT

A filter housing is provided for use with swimming pool filtration systems. The housing has an enlarged interior annular space between the housing wall and the filter, so as to facilitate the creation of fluid turbulence within the housing, which promotes more efficient filtration. The housing includes a base, a cover and a securing ring which is integrally attached to the cover and which facilitates the removal and attachment of the cover to the base. The cover is also provided with an improved pressure relief valve that has a lever which is rotated to open the valve quickly and vent excess air in the housing. The housing acts as a stop for preventing further rotation of the lever.

### CROSS REFERENCE TO RELATED APPLICATION

This application claims priority of U.S. Provisional Patent Application Ser. No. 60/733,440, filed Nov. 3, 2005, the disclosure of which is incorporated by reference herein in its entirety.

### FIELD OF THE INVENTION

The present invention relates to filter housings and, more particularly, to filter housings having features which enhance filtration and facilitate handling and maintenance of swimming pool filtration systems.

### BACKGROUND OF THE INVENTION

Various types of filter housings have been developed in the past for use in swimming pools. For instance, one type of filter housing is designed for use with a cartridge-type filter. Examples of such cartridge-type filter assemblies with filter housings are disclosed in U.S. Pat. Nos. 4,617,117, 5,871,641 and 6,217,754.

Known filter housings, such as the one disclosed in U.S. Pat. No. 6,217,754, suffer from various problems and disadvantages. For instance, the proximity of the filter cartridge to the interior wall of the housing does not promote highly efficient filtration. More particularly, limited annular space between the filter and the housing wall may prevent turbulent flow of the unfiltered fluid within the filter housing, resulting in an unevenly dispersed mixture of particles and an aggregation of particles settling at the bottom of the filter.

Swimming pool filter housings are also known to accumulate compressed air, which can lead to excess pressure in the housing, causing its components to violently separate or require disassembly. Accordingly, filter housings are provided with manual air relief valves. A stem on the relief valve is unscrewed to bleed off the excess pressure in the filter housing. Conventional relief valves, typically petcock-type valve devices, suffer from various problems and disadvantages. The valve stem can be unscrewed from the valve housing too far, to the point where it falls out of the housing, causing an interruption in the bleeding operation until the valve stem is located and replaced. Another problem with conventional petcock-type valves is that the rate of air bled through the valve depends on the degree to which the stem is unscrewed. This causes inefficient valve bleeding as well, since the petcock has to be opened as far as possible to vent the housing quickly, but such opening could take an unsatisfactory lengthy amount of time.

The relief valve disclosed in U.S. Pat. No. 5,435,339 aims to alleviate the problems inherent in conventional relief valves. However, the complicated structure and multiple components of the relief valve disclosed in U.S. Pat. No. 5,435,339 render it impractical and expensive to manufacture. For instance, locking tabs and pins that cooperate with camming in the valve housing are disclosed.

Another problem encountered in conventional filter housings involves the securing rings used to attach the top component, or cover, to the bottom component, or base. More particularly, such securing rings are typically separate from the filter housing components and must consequently be removed prior to, and separately from, removing the cover. This structural arrangement (i.e., a securing ring not integrated with the cover) both complicates operation of the filter housing, and compromises the efficiency thereof.

### SUMMARY OF THE INVENTION

The present invention overcomes the disadvantages and shortcomings discussed above. In accordance with a feature of the present invention, a filter housing is provided with a greater annular space between an inner wall of the housing and a filter cartridge. More particularly, the filter housing of the present invention is larger than conventional housings, including a greater radial distance from the housing wall to the filter, which promotes the creation of fluid turbulence within the filter housing. The fluid turbulence more evenly disperses the particles in an unfiltered fluid, thereby enhancing filtration efficiency by causing filtering to occur along the substantially entire area of the filter cartridge.

In accordance with another feature of the present invention, an improved pressure relief valve is provided. The valve may be quickly opened to vent excess air in the housing by rotating a lever. The top of the housing acts as a stop for preventing further rotation of the lever. The valve has a simple construction, making it more economical to manufacture and simpler to use.

Yet another feature of the present invention relates to a securing or locking ring which is integrated with a cover of the filter housing. The securing ring simplifies removal of the cover from a base of the filter housing, and also ensures secure placement thereon. Handles and latch assemblies on the securing ring are deployed to threadably engage or disengage the cover from the base.

Further features and advantages of the invention will appear more clearly on a reading of the detailed description of an exemplary embodiment of the invention, which is given below by way of example only with reference to the accompanying drawings.

### BRIEF DESCRIPTION OF THE DRAWINGS

For a more complete understanding of the present invention, reference is made to the following detailed description of an exemplary embodiment of the present invention considered in conjunction with the accompanying drawings, in which:

FIG. 1 is a perspective view of a filter housing constructed in accordance with an exemplary embodiment of the present invention;

FIG. 2 is an exploded perspective view of the filter housing shown in FIG. 1;

FIG. 3 is a cross-sectional view, taken along section line 3-3 and looking in the direction of the arrows, of the filter housing shown in FIG. 1, with an associated cartridge-type filter being depicted within the filter housing;

FIG. 4a is an enlarged cross-sectional view of portions of a cover and securing ring of the filter housing shown in FIG. 3, disengaged from a base of the filter housing;

FIG. 4b is an enlarged cross-sectional view of the cover and the ring of the filter housing shown in FIG. 3, with the base threadably engaging the ring;

FIG. 5 is a perspective, partially exploded view of the filter housing shown in FIG. 1;

FIG. 6 is an enlarged, broken-away perspective view of a handle and latching mechanism of the filter housing shown in FIG. 1;

FIGS. 7-9 are sequential, broken away views of the latch assembly shown in FIG. 6, schematically illustrating the unlatching sequence of the latch assembly of the filter housing shown in FIG. 1;

FIG. 10 is a perspective view of a pressure relief valve mounted on the filter housing of the present invention, wherein the valve is in a fully closed position;

FIG. 11 is a perspective view of the valve shown in FIG. 10, wherein the valve is in a fully open position;

FIG. 12 is an exploded view of the valve shown in FIG. 10; and

FIG. 13 is a cross-sectional view, taken along section line 13-13 and looking in the direction of the arrows, of the valve shown in FIG. 11.

### DETAILED DESCRIPTION OF THE EXEMPLARY EMBODIMENT

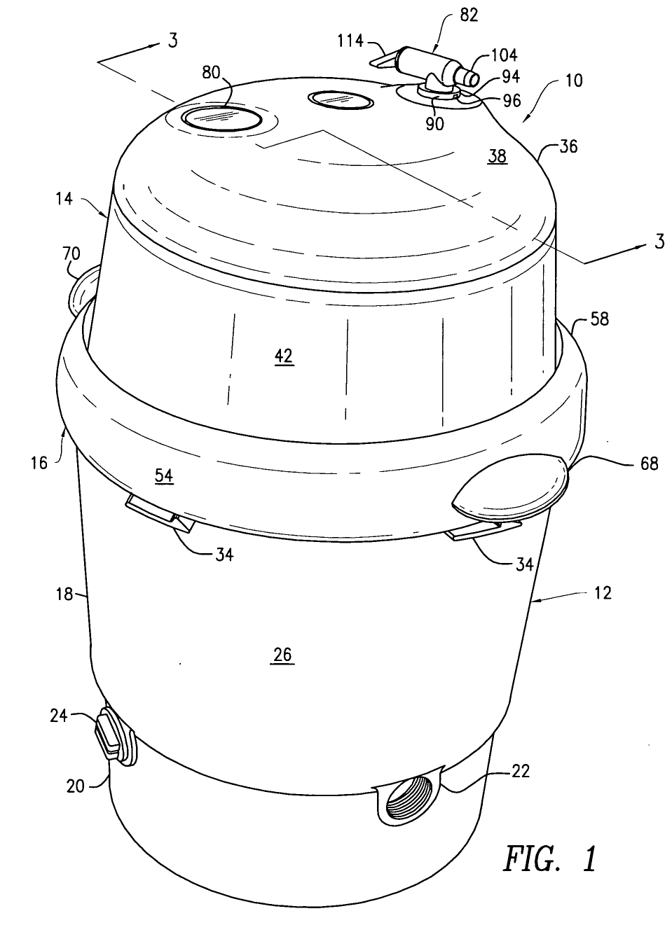

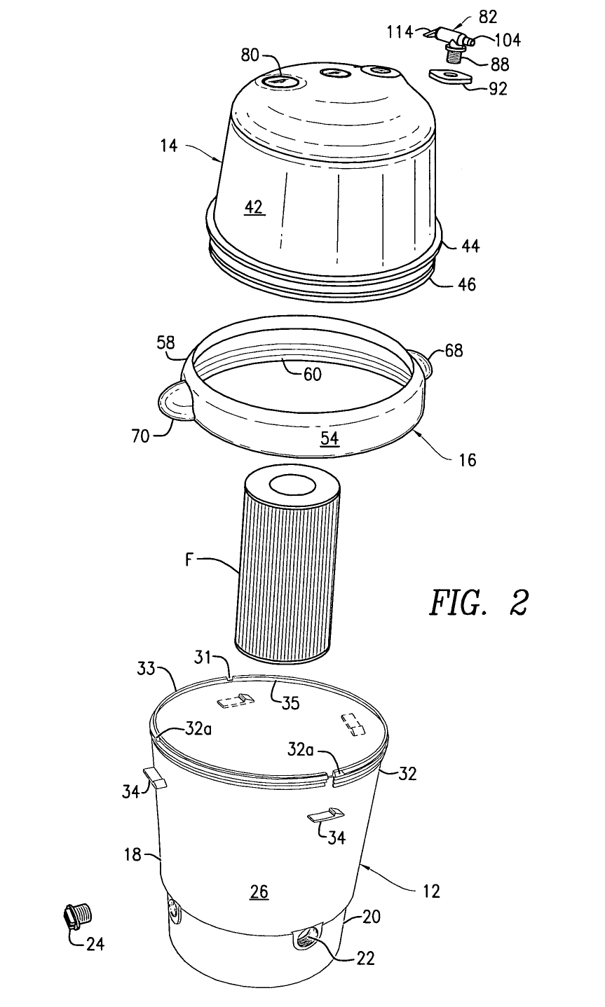

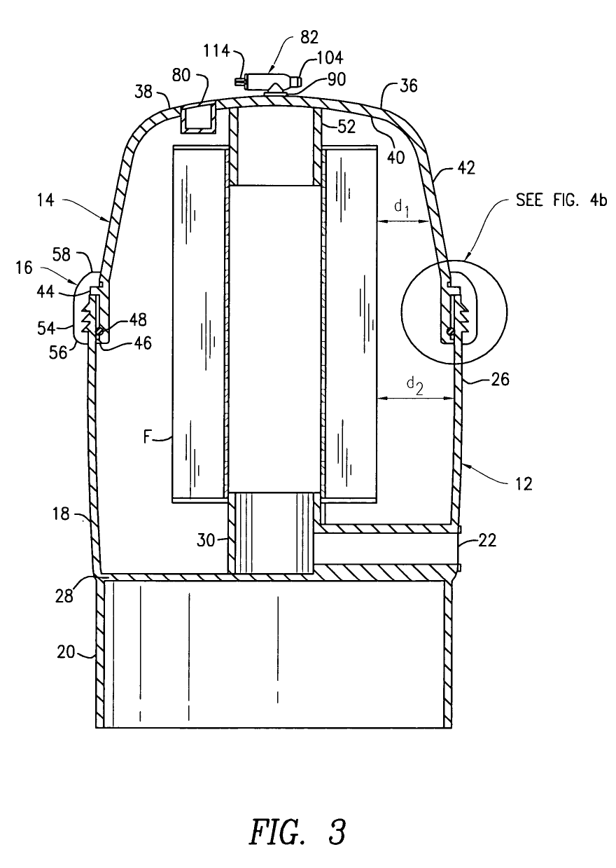

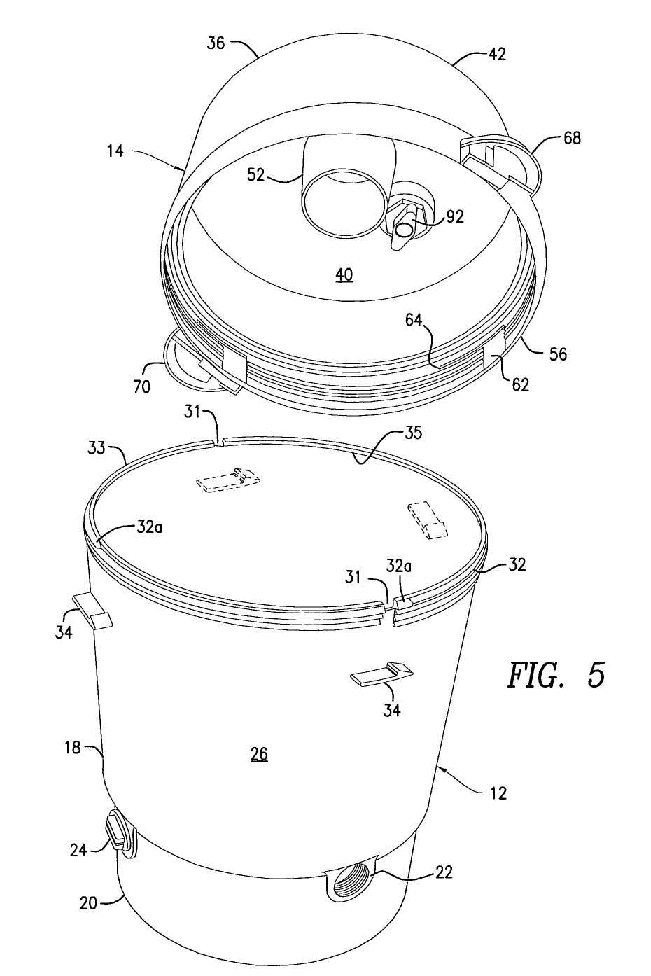

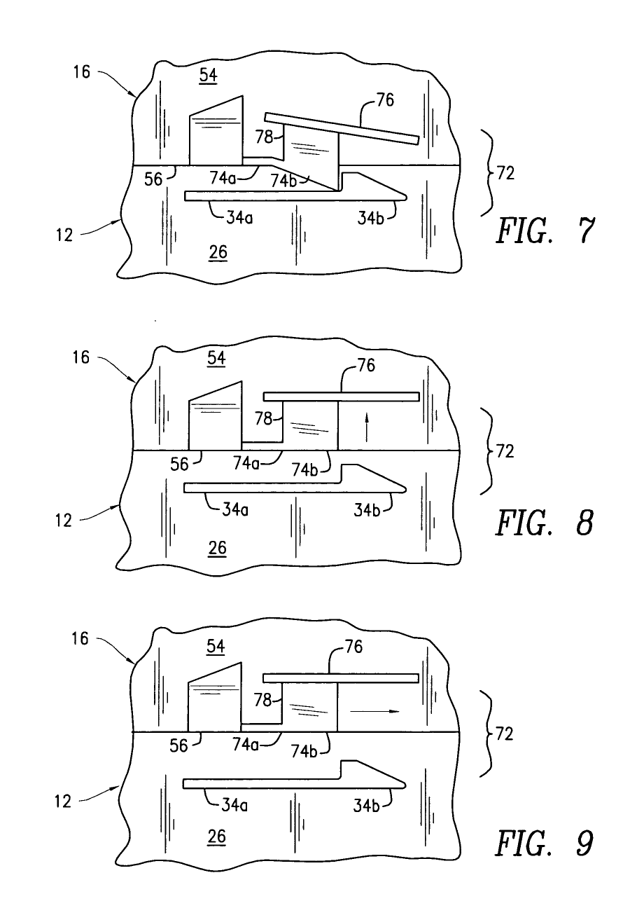

FIGS. 1-3 and 5 illustrate a filter housing 10 constructed in accordance with the present invention. The filter housing 10 includes a base 12 and a cover 14 which has an integral securing or locking ring 16 for removeably securing the cover 14 to the base 12. The base 12 is rounded, with a generally oval cross section as a result of the machining process and the materials used. The base 12 has an upper portion 18 and a lower portion 20. The lower portion 20 has standard filter housing features, including an outlet 22, an inlet (not shown) and a drain plug 24. The upper portion 18 comprises an annular wall 26 and a floor 28 (see FIG. 3), which separates the upper portion 18 from the lower portion 20. A hollow vertical support 30 extends upwardly from the floor 28, and may be integrally formed therewith so as to be in communication with the outlet 22 (see FIG. 3). The vertical support 30 is sized and shaped so as to receive a bottom opening of a cartridge filter F thereon. The upper portion 18 further includes circumferential external threading 32, which is formed on an outer surface of the wall 26, opposite the floor 28, and a plurality of tabs 34, which extend outwardly from the wall 26 proximate to the threading 32. The threading 32 has a plurality of threads, each including a top end thread 32a (see FIG. 5). Each of the tabs 34 has a linear portion 34a and an integrally connected triangular portion 34b (see FIGS. 7-9). The tabs 34 are arranged substantially evenly about the wall 26, so that each of the tabs 34 is about 90 degrees from both of the tabs 34 closest to it, and diametrically opposite the tab 34 farthest from it. Diametrically opposed notches 31 are also formed in an upper end 33 of the wall 26, while an annular groove 35 (see FIGS. 2, 4a, 4b and 5) is formed in an inner surface of the wall 26 adjacent the upper end 33 for purposes to be discussed hereinbelow.

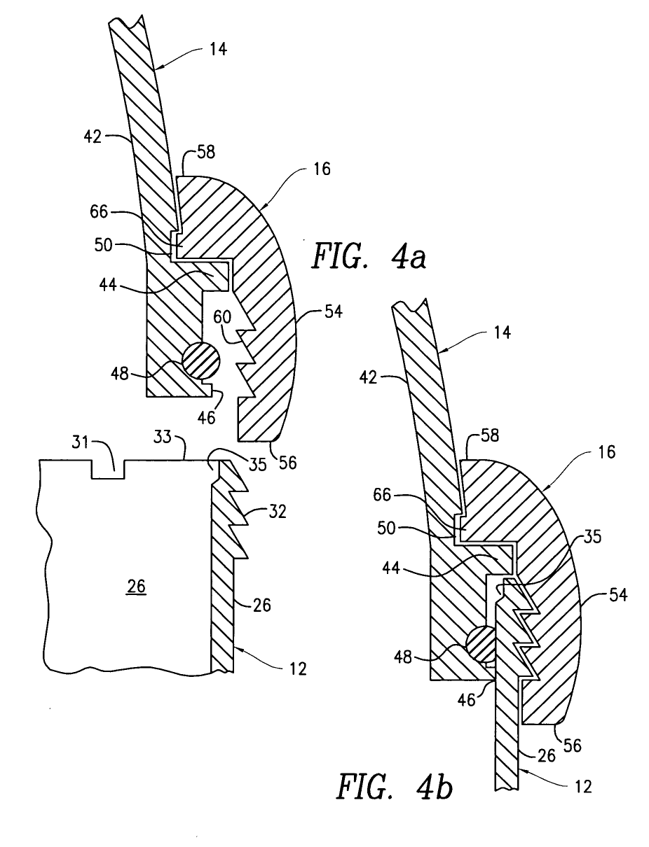

Referring now to FIGS. 1-5, 10 and 11, the cover 14 includes a dome-shaped top 36 having exterior and interior surfaces 38, 40, and a substantially frustoconical wall 42 integrally attached to the dome-shaped top 36. Upper and lower circumferential flanges 44, 46 (see FIG. 4a) extend radially outwardly from the frustoconical wall 42. More particularly, the upper and lower flanges 44, 46 are positioned adjacent a lower end of the frustoconical wall 42 and are substantially parallel to one another. An O-ring 48 is provided in an annular groove formed in the frustoconical wall 42 adjacent the lower flange 46 and between the upper and lower flanges 44, 46 (see FIGS. 4a and 4b). An annular notch 50, the purpose of which will be discussed hereinbelow, is formed in the frustoconical wall 42, adjacent the upper flange 44 and positioned between the upper flange 44 and the dome-shaped top 36. A vertical stabilizing member 52 extends downwardly from the center of the interior surface 38 of the dome-shaped top 36, and may be integrally formed therewith (see FIG. 5). The vertical stabilizing member 52 is sized and shaped so as to fit into a top opening of the filter F, and to stabilize the same on the vertical support 30 and within the filter housing 10, as shown in FIG. 3.

FIG. 3 also illustrates a radial distance d₁ between the filter F and the frustoconical cover wall 42, and a radial distance d₂ between the filter F and the annular base wall 26. The cover 14 and base 12 are constructed so that distances d₁ and d₂, respectively, are greater than corresponding dimensions in conventional filter housings. For instance, in one embodiment, d₁ ranges from approximately 2 to 2.5 inches and d₂ ranges from approximately 3 to 3.5 inches. Generally, the total diameter of the filter housing 10 is preferably greater than the diameter of the filter F by approximately 75%. The greater distances d₁, d₂ between the filter F and the walls of the filter housing components, and the resulting greater annular space about the filter F promotes the creation of fluid turbulence within the filter housing 10. Such turbulence in turn promotes filtration along the substantially entire length and circumference of the filter F, thereby enhancing its overall performance. More particularly, the enlarged annular space allows turbulent motion of the unfiltered fluid to occur within it, which mixes the particles suspended in the fluid to evenly distribute the particles. The evenly distributed particles tend to come into contact with more of the filter surface, resulting in a more widely dispersed spread of the filtered particles.

Referring now to FIGS. 1-11, the securing ring 16 has a side wall 54 and a bottom edge 56. The ring 16 is preferably fabricated from a heavier, more rigid material than the base 12, for reasons to be discussed hereinbelow. The ring 16 also includes a shoulder 58, which is sized and shaped so as to engage the upper flange 44 of the frustoconical wall 42, and internal threading 60 which is positioned between the shoulder 58 and the bottom edge 56. The internal threading 60 is interspersed with a plurality of evenly spaced grooves 62 (see FIG. 5). More particularly, the grooves 62 are arranged substantively evenly about the side wall 54, so that each of the grooves 62 is about 90 degrees from both of the grooves 62 closest to it, and diametrically opposite the groove 62 farthest from it. Each of the grooves 62 extends along the height of the side wall 54, and each includes an elongated closed channel 64 (see FIG. 5), the purpose of which will be explained hereinbelow.

Referring now to FIGS. 4a and 4b, an annular ridge 66 extends inwardly from the shoulder 58 of the ring 16. Preferably, the ridge 66 is in the form of a plurality of evenly spaced tabs, each of which is sized and shaped so as to insertably engage the annular notch 50 in the frustoconical wall 42 of the cover 14, thereby forming an interference fit between the ring 16 and the cover 14. This arrangement allows the ring 16 to be securely and permanently snapped onto the cover 14, distal to the dome-shaped top 36. Attaching the ring 16 to the cover 14 facilitates mounting and/or removal of the cover 14, as will be further discussed hereinbelow.

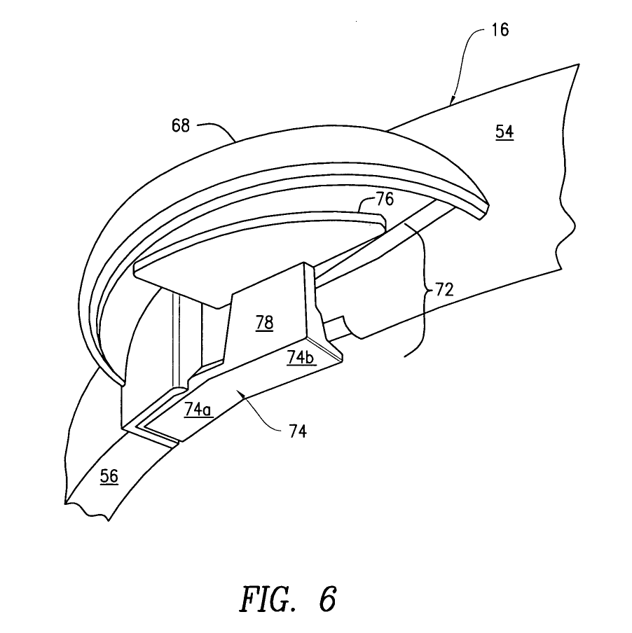

Referring now to FIGS. 1, 2 and 5-9, the ring 16 further includes a plurality of handles 68, 70, which are diametrically opposed about the side wall 54, and a latch assembly 72 proximate each of the handles 68, 70. To facilitate consideration and discussion, FIGS. 5 and 6 show the latch assembly 72 within the handles 68, 70, and FIGS. 7-9 illustrates the latch assembly 72 with the handles 68, 70 broken away. Each latch assembly 72 include a locking member 74 and a lever 76 integrally connected thereto. The locking members 74 each includes a rigid portion 74a and a flexible portion 74b integrally attached to the rigid portion 74a. The rigid portions 74a are connected to, and are substantially coplanar with, the bottom edge 56 of the ring 16. Each of the flexible portions 74b, in its extended position, is positioned below the associated rigid portion 74a and the bottom edge 56 (see FIGS. 6 and 7). The levers 76 are positioned so as to be contained within the handles 68, 70. Each latch assembly 72 also includes a connecting member 78 that connects the lever 76 to the flexible portion 74b of the locking member 74. The operation of the latch assembly 72 will be discussed hereinbelow.

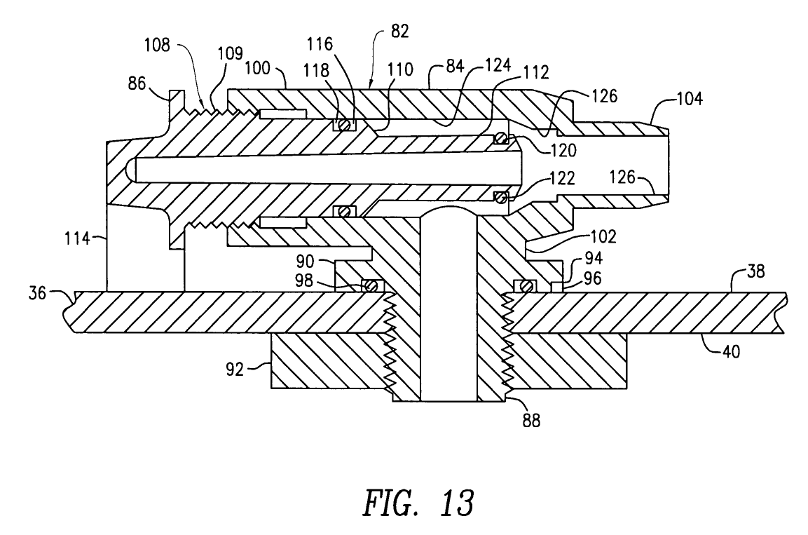

Referring now to FIGS. 1-3 and 10-13, the dome-shaped top 36 of the cover 14 is provided with a pressure gauge 80 and an air pressure relief valve 82. The valve 82 has a hollow valve body 84, a hollow valve stem 86 and a hollow, threaded bottom portion 88. The valve body 84 has a circular base or flange 90 that integrally connects the valve body 84 to the bottom portion 88. The bottom portion 88 is inserted through an opening in the dome-shaped top 36 and threadably engages a nut 92 adjacent the interior surface 40 of the dome-shaped top 36 to secure the valve 82 in place on the exterior surface 38. The base 90 is keyed, and has a notch 94 therein (see FIG. 13). A complementary protrusion 96 projects from the exterior surface 38 of the dome-shaped top 36 so as to fit into the notch 94 of the valve base 90, thereby ensuring proper positioning of the valve 82 relative to the cover 14 and preventing rotation of the valve 82 relative to the cover 14. The base 90 also contains an O-ring 98 for providing a fluid-tight seal between the valve 82 and the cover 14 (see FIG. 13).

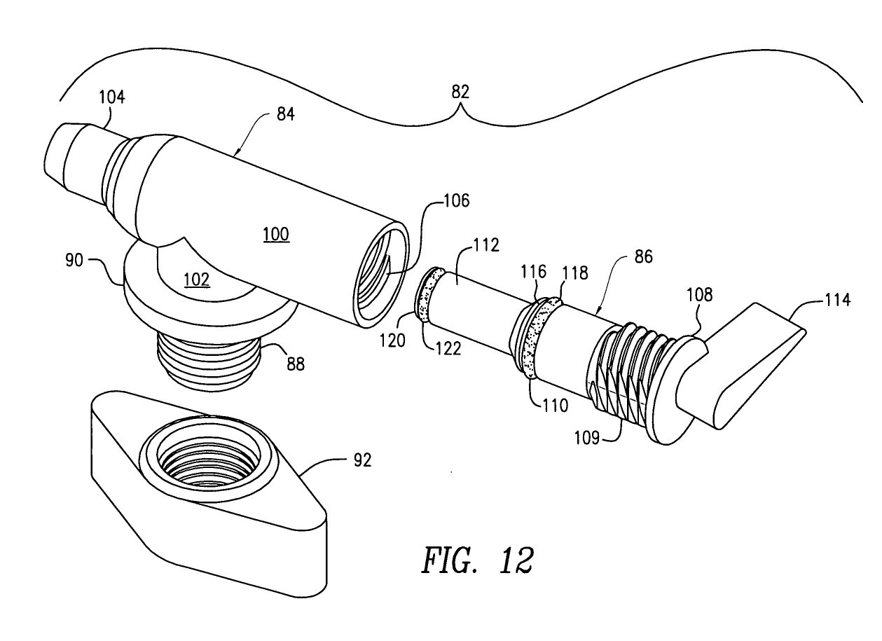

With reference to FIGS. 12 and 13, the valve body 84 has a cylindrical primary portion 100 and a cylindrical support portion 102 integrally connected to the primary portion 100 so as to be perpendicular thereto. The primary and support portions 100, 102 are both hollow, and communicate at the intersection thereof, which is preferably at the approximate longitudinal midpoint of the primary portion 100. Preferably, the primary portion 100 is longer than the support portion 102. The support portion 102 extends between the primary portion 100 and the base 90, and the hollow space of the support portion 102 is continuous with that of the threaded bottom portion 88. A reduced-diameter, unthreaded nipple 104 extends from one end of the primary portion 100. The nipple 104 functions as an exit port for the valve 82. The opposite end of the primary portion 100 is open and includes interior threading 106 therein, the purpose of which will be further discussed hereinbelow.

Still referring to FIGS. 12 and 13, the valve stem 86 is substantially cylindrical. The stem 86 has a first end 108 which has exterior threading 109 and a second end 110 with a reduced-diameter section 112 extending therefrom. A valve lever 114 is integrally attached to the threaded end 108 of the stem 86. The unthreaded second end 110 includes an annular groove 116 into which is fitted an O-ring 118. Likewise, the distal end of the reduced-diameter section 112 includes a groove 120 into which is fitted an O-ring 122. Both O-rings 118, 122 seal the interior of the valve 82 so as to prevent fluid in the filter housing 10 from escaping through the valve 82. More particularly, the O-ring 118 is in constant engagement with an interior surface 124 (see FIG. 13) of the primary portion 100 of the valve body 84, forming a seal between the primary portion 100 and the stem 86. The O-ring 122 is adapted to engage an interior surface 126 of the nipple 104 when the valve 82 is in its fully closed position (not shown), thereby preventing fluid passage through the nipple 104.

During the assembly of the filter housing 10, the filter F is placed on the vertical support 30 within the base 12. The cover 14 is then placed on the base 12 and secured thereto. More particularly, the vertical stabilizing member 52 is inserted into the top opening of the filter F as the cover 14 is placed on top of the base 12. Once the filter F is secured inside of the housing 10, the cover 14 and ring 16 are arranged on the base 12 so that the exterior threading 32 of the base 12 and interior threading 60 of the cover 14 are aligned (see FIGS. 4a and 4b). The handles 68, 70 are then used to rotate the ring 16 clockwise to attach the cover 14 to the base 12. The latch assembly 72 facilitates attachment of the ring 16, and thereby the integrated cover 14, onto the base 12. That is, the ring 16 is rotated in a clockwise direction, ultimately moving the flexible portions 74b of the locking members 74 into engagement with the triangular portions 34b of a diametrically opposed pair of the tabs 34 of the base 12. Once the flexible portions 74b are moved past the triangular portions 34b, the flexible portions 74b snap audibly as they descend and impact the linear portions 34a of the tabs 34 (see FIG. 7). The snapping sound indicates to a user that the cover 14 and ring 16 are properly secured to the base 12. The tabs 34 and the flexible portions 74b of the locking members 74 thus engage each other to prevent inadvertent unlocking of the cover 14 from the base 12. Furthermore, once the ring 16 has been rotated to this position (see FIGS. 4b and 7), the top end threads 32a of the base 12 are positioned in the closed channels 64 of the grooves 62, and thereby prevent further clockwise rotation of the ring 16. When the ring 16 and the cover 14 are attached in this manner, the O-ring 48 forms a piston-type seal between the frustoconical cover wall 42 and the annular base wall 26 (See FIG. 4b). At this point, the cover 14 is secured to the base 12 and operation of the filter can begin safely. In addition, because the ring 16 is made of a more rigid plastic than the base 12, the ring 16, which is generally circular, will conform the generally oval base 12 to a generally circular shape.

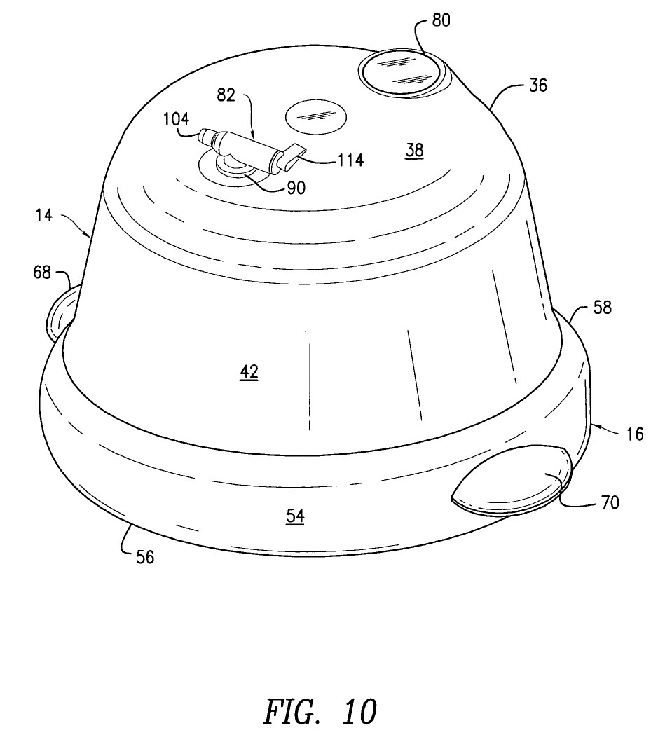

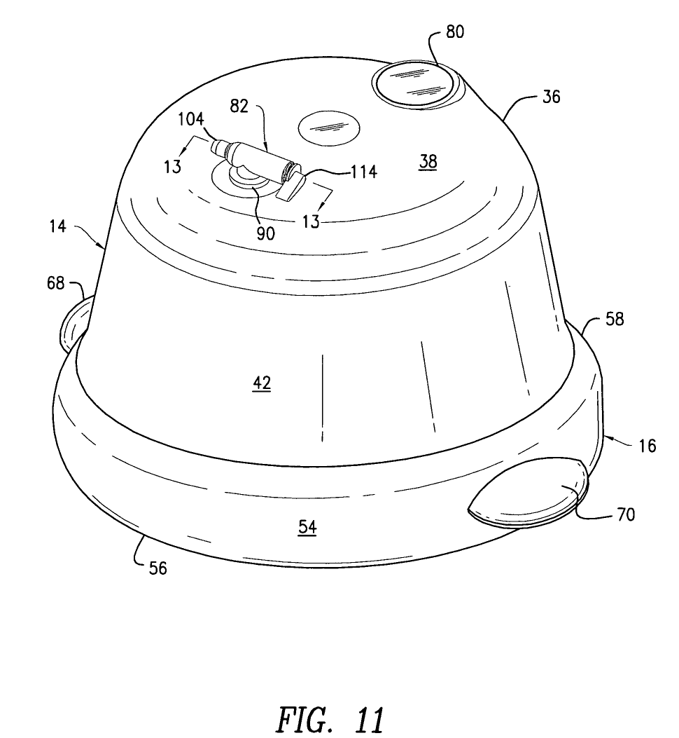

The filter housing 10 must be opened periodically to access the filter F when it requires cleaning or replacement (for instance, when the fluid pressure exceeds the starting pressure by 5-7 psi). Once the pool pump has been turned off and steps are taken to prevent backflow from the pool, the valve 82 is opened with a counter-clockwise turn of the valve lever 114 to release air trapped within the filter housing 10. More particularly, the valve lever 114 is rotated counter-clockwise from a closed position, (see FIG. 10), to an open position wherein the valve lever 114 abuts the exterior surface 38 of the dome-shaped top 36, and cannot be rotated further (see FIGS. 11 and 13). The threading 106 of the primary portion 100 and the threading 109 of the valve stem 86 are designed such that a turn of the valve lever 114 from the position shown in FIG. 10 to the position shown in FIG. 11 opens up the valve 82 fully for an air-venting operation. Air leaves the filter housing 10 and travels through the valve bottom portion 88 and the valve body 84 before exiting through the nipple 104. After properly venting the filter housing 10, the filter housing 10 is drained of any fluid within it by removing the drain plug 24. Once these safety steps have been taken, the cover 14 may be safely removed as described hereinbelow.

Referring to FIGS. 4a and 6-9, the cover 14, which is secured to the base 12 via the ring 16, is now removed therefrom. More particularly, the levers 76 of the latch assemblies 72 under each of the handles 68, 70 are moved or rotated upwardly from an extended position (see FIG. 7), in which the flexible portions 74b of the locking members 74 are in locking engagement with the tabs 34, to a retracted position (see arrow in FIG. 8), in which the flexible portions 74b of the locking members 74 are disengaged from the tabs 34. Rotating the levers 76 in this way causes the respective connecting members 78 to raise the flexible portions 74b a vertical distance, which enables the flexible portions 74b to be passed over their associated tabs 34 on the base 12. More particularly, once the flexible portions 74b are raised, the handles 68, 70 can be used to rotate the ring 16 in a counterclockwise direction (see arrow FIG. 9). The ring 16 is thereby unthreaded from the base 12, whereupon the levers 76 may be released and returned to their extended position.

As the ring 16 and the cover 14 are lifted by the unthreading motion (but before they are fully disengaged from the base 12), the O-ring 48 is moved upwardly along the wall 26 into the annular groove 35 (see FIGS. 4a and 4b). The movement of the O-ring 48 into the annular groove 35 allows the O-ring 48 to relax and thereby release some of the compressed air in the housing 10 through the notches 31 in the upper end 33 of the annular base wall 26 while the cover 14 is partially attached to the base 12 (i.e., before the cover 14 is removed from the base 12). The annular groove 35 and notches 31 thus act as a back-up safety feature in case the valve 82 was not opened prior to opening the housing 10. More particularly, the operation of the O-ring 48 moving into the annular groove 35 and releasing compressed air through the notches 31 reduces the housing air pressure to a safe level that will not result in violent separation of the cover 14 from the base 12 if the valve 82 was not first used to bleed the compressed air. The ring 16 and the attached cover 14 may then be removed from the base 12 (see FIGS. 4a and 5). Since the ring 16 is attached to the cover 14, a separate operation for removing the cover 14 is unnecessary, thus simplifying this process. After the cover 14 and ring 16 have been removed from the base 12, the filter F may be removed for cleaning or replacement.

It should be appreciated that the present invention provides numerous advantages over the prior art discussed above. More particularly, the enlarged interior space of the filter housing 10 facilitates the creation of fluid turbulence within the housing 10, and hence, more efficient filtration.

In addition, the securing ring 16 of the present invention facilitates easier and safer operation and maintenance of the filter housing 10. More particularly, because the ring 16 is integrally attached to the cover 14, removal/attachment of the cover 14 from the base 12 can be achieved automatically with the removal/attachment of the ring 16. For instance, the ring 16 of the present invention enables a user to combine the steps of removing the ring 16 and then removing the cover 14 separately. Furthermore, the snapping sound created by engagement of the locking members 74 with the tabs 34 of the base 12 when the ring 16 is rotated onto the base 12 signals the complete attachment of the cover 14 to the base 12, at which point the closed channels 64 of the grooves 62 in the ring 16 receive the top end threads 32a to prevent further rotation of the ring 16.

The air pressure relief valve 82 of the present invention also provides advantages over the prior art. The valve 82 is of a simple and relatively inexpensive construction with a minimal number of moving parts. Nevertheless, the valve 82, once opened, effectively and quickly removes air trapped in the housing 10 with a partial turn of the lever 114. The dome-shaped top 36 of the cover 14 itself acts as a stop for the lever 114, preventing the separation and potential loss of the valve stem 86. In addition, the notch 94 in the base 90 of the valve 82 engages the protrusion 96 from the dome-shaped top 36 of the cover 14 to provide an efficient, low-cost method for stabilizing the valve 82.

Another advantage of the present invention is the inclusion of a back-up safety system whereby compressed air is released from the housing 10 before removal of the cover 14 from the base 12, even if the valve 82 is not first opened. More particularly, the enlarged annular groove 35 receives the O-ring 48 as it passes over the annular base wall 26, facilitating the release of compressed air through the notches 31.

The presence of two pairs of tabs 34 about the base 12 of the housing 10 constitutes a further advantage of the present invention. More particularly, a user may secure the latch assemblies 72 of the ring 16 to the tabs 34 of either diametrically opposed pair, thereby requiring the ring 16 to be moved a shorter distance.

It should be noted that the present invention can have numerous modifications and variations. For instance, depending on the need of the pool owner, larger or smaller sized filter housings are available. Likewise, different methods of attaching the ring 16 to the cover 14 may also be employed.

It will be understood that the embodiment described herein is merely exemplary, and that a person skilled in the art may make many variations and modifications without departing from the spirit and scope of the invention. All such variations and modifications, including those discussed above, are intended to be included within the scope of the invention as defined in the appended claims.

I claim:

1. A filter housing, comprising:
a base having an annular wall including circumferential external threading proximate an upper end of said annular wall and a plurality of tabs extending outwardly from said annular wall, proximate said external threading, a floor engaging a lower end of said annular wall and a vertical support extending upwardly from said floor, said vertical support being sized and shaped so as to engage a bottom end of a cartridge filter;
a cover having a substantially frustoconical wall, a top having exterior and interior surfaces and connected to an upper end of said frustoconical wall, and a stabilizing member extending downwardly from said top, said stabilizing member being sized and shaped so as to engage a top end of the cartridge filter such that the filter is stabilized between said vertical support and said stabilizing member;
a securing ring engaging a lower end of said frustoconical wall, said securing ring having a bottom edge, a shoulder sized and shaped so as to engage the lower end of said frustoconical wall, a side wall connecting said bottom edge to said shoulder, internal threading positioned between said shoulder and said bottom edge and dimensioned so as to engage said annular base wall external threading, a plurality of handles arranged circumferentially about said side wall, and a plurality of latch assemblies, each of said latch assemblies being positioned proximate one of said handles and including a locking member and a lever, each of said locking members having a flexible portion connected to a proximate one of said levers and a rigid portion connected to and substantially coplanar with said securing ring bottom edge, said lever being movable between an extended position, in which said flexible portion is extended so as to be positioned below said securing ring bottom edge and said rigid portion, and a retracted position, in which said flexible portion is retracted so as to be substantially coplanar with said securing ring bottom edge and said rigid portion; and
an air pressure relief valve mounted to said exterior top surface, said valve having a hollow valve body including a primary portion having opposed ends and a support portion in communication with said primary portion at a point intermediate said opposed open ends, said primary portion having a nipple at one of said opposed ends and interior threading at the other of said opposed ends, a hollow bottom portion in communication with said support portion and insertably engaging said exterior top surface so as to be in communication with the interior space of said housing, and a hollow valve stem having first and second ends, said first end having a lever and exterior threading proximate said lever, and said second end having a reduced-diameter section extending therefrom, said stem insertably engaging said valve body primary portion at said opposed end having interior threading, such that said reduced-diameter section is proximate said nipple and said exterior threading engages said interior threading, said lever being movable between a first position, in which said valve lever is not in contact with said exterior top surface and said valve is closed, and a second position, in which said valve lever is in contact with said exterior top surface and said valve is open.
